(19) United States
(12) Patent Application Publication
(10) Pub. No.: US 2025/0342368 A1
(43) Pub. Date: Nov. 6, 2025

(54) ANALYSIS-DRIVEN AUTOMATED INFRASTRUCTURE UPGRADES FOR DATA CENTER SERVERS

(71) Applicant: Dell Products L.P., Round Rock, TX (US)

(72) Inventors: Nithish Kote, Bangalore (IN); Swati Negi, Bangalore (IN); Vishnu Murty Karrotu, Hyderabad (IN)

(21) Appl. No.: 18/656,147

(22) Filed: May 6, 2024

(51) Int. Cl. G06N 5/022

(52) U.S. Cl. CPC G06N 5/022

(57) ABSTRACT

A method facilitating analysis-driven automated infrastructure upgrades for data center servers includes determining, by a first system including at least one processor and using a machine learning model applied to recorded performance metrics for a workload performed at a first time by a second system configured according to a recorded configuration, predicted performance metrics for the workload as performed by the second system at a second time that is after the first time for respective candidate configurations, including the recorded configuration, of the second system at the second time; and generating, by the first system and based on the predicted performance metrics, a recommendation associated with changing the recorded configuration of the second system to a candidate configuration of the candidate configurations.

### BACKGROUND

In order to ensure smooth and accurate data processing in a cloud computing environment such as a cloud-based data center, it is desirable to periodically update and maintain server devices and/or other computing devices associated with a cloud computing deployment. However, because a typical cloud computing environment often includes many different computing devices with different needs and components, it can be challenging for a server administrator or other user responsible for the upkeep of a cloud computing environment to select and implement equipment upgrades in an efficient manner.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one memory that stores executable components and at least one processor that executes the executable components stored in the at least one memory. The executable components can include a performance modeler that predicts, using a machine learning model and based on benchmark data associated with past performance metrics for a workload as performed by a computing system configured according to a first configuration, future performance metrics for the workload for respective candidate configurations, including the first configuration, of the computing system. The executable components can further include an upgrade recommendation engine that, based on the future performance metrics predicted by the performance modeler, generates a recommendation associated with changing the first configuration of the computing system to a second configuration of the candidate configurations.

In another implementation, a method is described herein. The method can include determining, by a first system including at least one processor and using a machine learning model applied to recorded performance metrics for a workload performed at a first time by a second system configured according to a recorded configuration, predicted performance metrics for the workload as performed by the second system at a second time that is after the first time for respective candidate configurations, including the recorded configuration, of the second system at the second time. The method can further include generating, by the first system and based on the predicted performance metrics, a recommendation associated with changing the recorded configuration of the second system to a candidate configuration of the candidate configurations.

In an additional implementation, a non-transitory machine-readable medium is described herein that can include instructions that, when executed by at least one processor, facilitate performance of operations. The operations can include predicting, using a machine learning model and based on performance data associated with first performance metrics for a workload as performed by a computing system while configured according to a first configuration, second performance metrics for the workload as performed by the computing system while configured according to respective candidate configurations comprising the first configuration; and, based on the second performance metrics, generating a recommendation associated with changing the first configuration of the computing system to a second configuration of the candidate configurations.

### DESCRIPTION OF DRAWINGS

Various non-limiting embodiments of the subject disclosure are described with reference to the following figures, wherein like reference numerals refer to like parts throughout unless otherwise specified.

FIGS. 1-3 are block diagrams of respective systems that facilitate analysis-driven automated infrastructure upgrades for data center servers in accordance with various implementations described herein.

FIG. 4 is a diagram depicting an example three-phase framework that can be utilized to facilitate analysis-driven automated infrastructure upgrades for data center servers in accordance with various implementations described herein.

FIG. 5 is a diagram depicting respective functions that can be performed by the data collector of FIG. 2 and/or FIG. 3.

FIGS. 6-7 are diagrams depicting example machine learning model frameworks that can be used to facilitate various implementations described herein.

FIG. 8 is a diagram depicting example data that can be collected and analyzed to facilitate analysis-driven automated infrastructure upgrades for data center servers in accordance with various implementations described herein.

FIG. 9 is a diagram depicting an example user interface that can be used in connection with various implementations described herein.

FIG. 10 is a flow diagram of a method that facilitates analysis-driven automated infrastructure upgrades for data center servers in accordance with various implementations described herein.

FIG. 11 is a flow diagram depicting respective operations facilitating analysis-driven automated infrastructure upgrades for data center servers that can performed by at least one processor in accordance with various implementations described herein.

FIGS. 12-13 are diagrams of respective example computing environments in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

In a cloud environment such as a data center or the like, workloads are typically carried out via server devices and/or other similar computing devices. To this end, it is desirable to regularly update and maintain server devices and/or other computing devices in a cloud environment to ensure smooth processing performance.

Data center environments and/or other similar cloud computing environments are generally built out progressively over time, meaning that a typical cloud computing environment can have multiple generations of heterogeneous servers and components working together. This variety of servers and components, however, can introduce complexities in ensuring that hardware updates are initiated and rolled out efficiently. For instance, a server for a data center environment is often purchased together with support for components such as solid state drives (SSDs), hard disk drives (HDDs), non-volatile memory express (NVMe) drives, networking components, or the like. In selecting components and/or associated support, however, a system administrator or other user may need to perform extensive assessments in order to make decisions that suit the needs of the system. In such a scenario, a large portion of administrator time can be spent analyzing new components and/or associated support, e.g., by going through multiple documents, support matrices, discussion forums, and/or other sources, instead of working on minimizing system downtime and/or other important administrative activities.

In addition, new features and hardware devices are periodically introduced in order to improve server performance. These can include, for example, platform updates; introduction of newer components such as processors, power supplies or power components, storage devices such as SSDs and/or NVMe drives; improved storage support; and/or other features or components. In order to simplify the server upgrade process due to the challenges presented above, system administrators usually wait for the end of life (EOL) term of a server before performing upgrades. However, this can adversely impact computing performance, particularly for computing systems that are expected to take on new and/or larger workloads over time.

In view of at least the above, implementations described herein can provide automated and analysis-driven recommendations for upgrades in a cloud computing environment, such as a data center or the like. In doing so, implementations described herein can case the burden on system administrators associated with keeping track of enhancements and upgrades in the server ecosystem, including software releases, firmware updates, and new hardware. Implementations as provided herein can provide a data analytics engine that possesses the ability to not only predict future system needs but also provide precise guidance, supported by technical justifications, for recommended upgrades. By leveraging these capabilities, system administrators can be kept updated on relevant updates and hardware advancements, enabling them to make informed decisions without the need for extensive manual analysis.

In implementations as described herein, predictive analysis models can be used to forecast future performance needs of a computing system, based on which component additions, infrastructure improvements, or the like can be suggested, e.g., to better handle anticipated workload growth or changes to system needs over time. Additionally, implementations described herein can provide a dynamic, intelligent method to suggest hardware upgrades based on new features as they become available. This can eliminate the bridge from marketing, sales, and/or support teams to a client system, e.g., via a proactive approach that includes real-time statistical monitoring and feature alerts to help administrators stay informed about the latest hardware advancements and make informed decisions regarding potential upgrades. Moreover, implementations described herein can facilitate monitoring a cloud system environment to identify real or potential issues affecting performance of the environment and provide suggestions to an administrator with comprehensive insights, enabling the administrator to better resolve the issue.

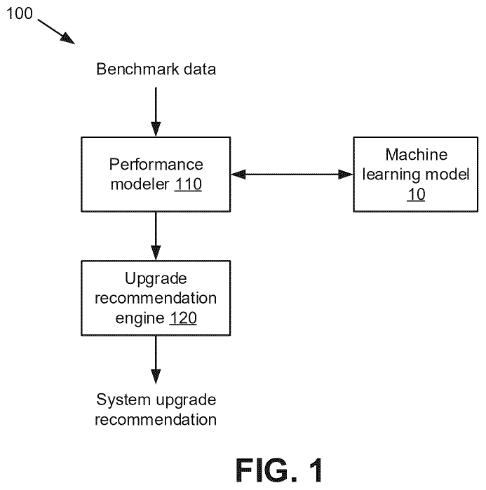

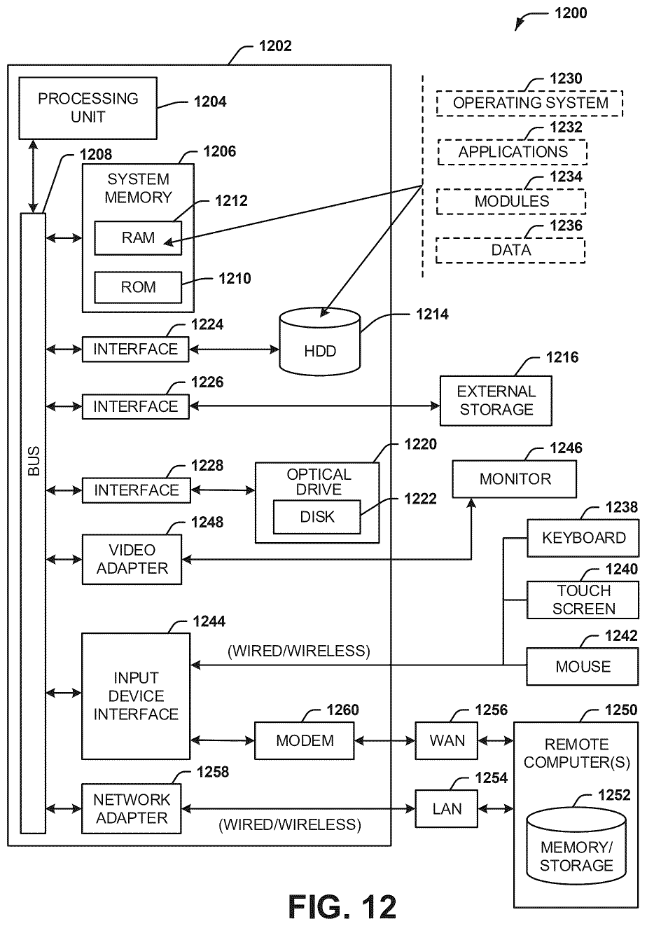

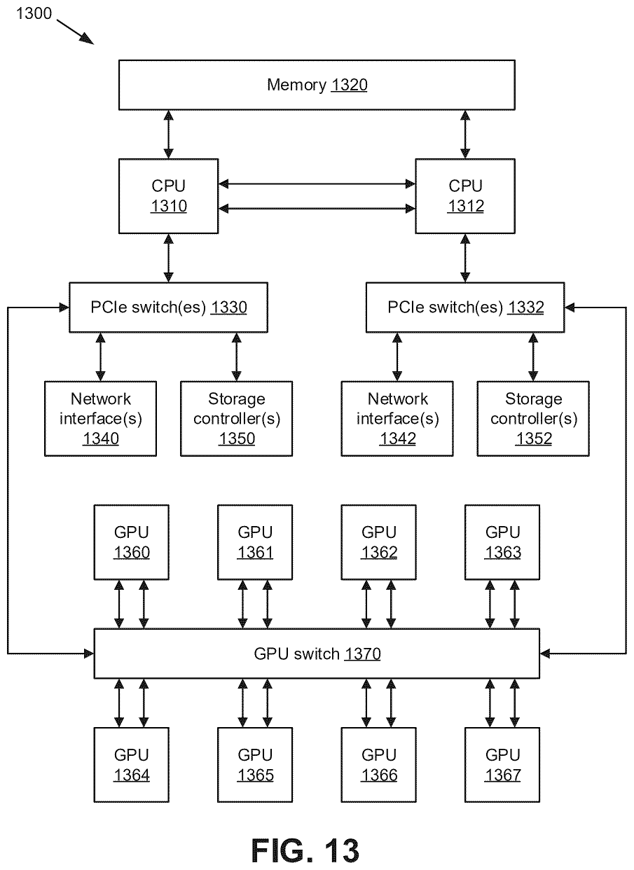

With reference now to the drawings, FIG. 1 illustrates a block diagram of a system 100 that facilitates analysis-driven automated infrastructure upgrades for data center servers in accordance with various implementations described herein. System 100 as shown in FIG. 1 includes executable components, e.g., a performance modeler 110 and an upgrade recommendation engine 120, each of which can operate as described in further detail below. In an implementation, the components 110, 120 of system 100 can be implemented in hardware, software, or a combination of hardware and software. By way of example, the components 110, 120 can be stored on at least one memory and executed by at least one processor. Examples of computer architectures including processors and memories that can be used to implement the components 110, 120, as well as other components as will be described herein, are shown and described in further detail below with respect to FIGS. 12-13.

Additionally, it is noted that the functionality of the respective components shown and described herein can be implemented via a single computing device and/or a combination of devices. For instance, in various implementations, performance modeler 110 shown in FIG. 1 could be implemented via a first device, and the upgrade recommendation engine 120 could be implemented via the first device or a second device. Also, or alternatively, the functionality of a single component could be divided among multiple devices in some implementations.

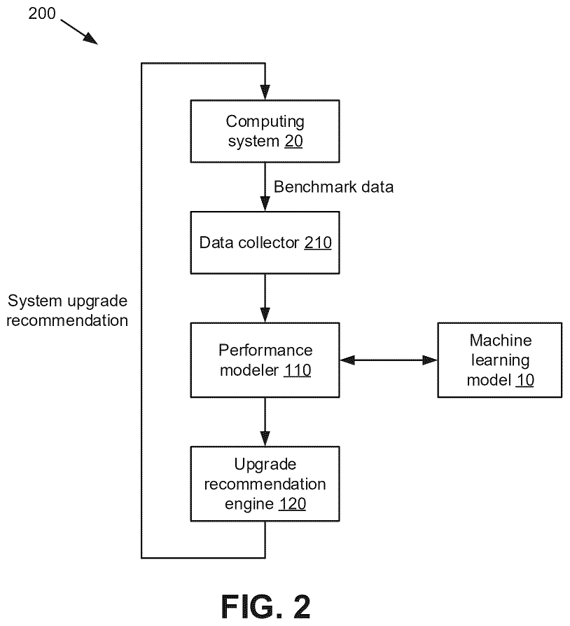

With reference now to the components of system 100, the performance modeler 110 can process benchmark data associated with past performance metrics for a workload as performed by a computing system, e.g., while the computing system is configured according to a first configuration, using a machine learning (ML) model 10. In implementations, benchmark data used by the performance modeler 110 in this manner can be collected directly from the computing system associated with the benchmark data, e.g., as will be described in further detail below with respect to FIG. 2. Using the ML model 10, and based on the benchmark data, the performance modeler 110 can predict future performance metrics for the workload as performed by the computing system for respective candidate configurations, including the first configuration associated with the past performance metrics, of the computing system. To state this another way, the performance modeler 110 can model the past performance of a computing system with the aid of an ML model 10, and based on this modeling the performance modeler 110 can predict the future performance of the computing system, both with its current configuration (e.g., settings, hardware devices, etc.) as well as with potential new configurations (e.g., changed or additional settings, different and/or additional hardware devices, etc.).

Based on the future performance metrics of the computing system as predicted by the performance modeler 110, the upgrade recommendation engine 120 can generate a recommendation associated with changing the configuration of the computing system, e.g., from the first configuration associated with the past performance metrics used by the performance modeler 110 to a second, new configuration of the candidate configurations considered by the performance modeler 110. Actions that can be taken based on this recommendation will be described in further detail below with respect to FIG. 1.

The above and/or other implementations as described herein can provide various advantages that can improve the performance of a computing system. For instance, the performance of a computing system can be proactively upgraded, either automatically and/or based on automatically provided suggestions, to ensure continued optimal performance of a computing system as the workloads performed by the computing system increase in terms of size and/or complexity. Additionally, system maintenance tasks that were previously not able to be automated, such as those associated with analyzing system performance, selecting upgraded and/or additional system components, and optimally configuring said components can be automated via a set of logical rules, which can increase the amount of time available to system administrators for performing everyday system maintenance tasks. Other advantages of the implementations described herein are also possible.

It is noted that while some implementations are described herein with reference to specific types of computing systems, such as data center deployments, any reference to specific types of computing systems provided herein are intended merely as non-limiting examples. The implementations described herein could be applied to any suitable computing system that utilizes heterogeneous devices and/or components to realize some or all of the benefits as described above without departing from the scope of this description or the claimed subject matter. It is also noted that, due to the nature and quantity of data that can be processed by ML models as described herein, as well as the manner in which such data is processed, implementations described herein can facilitate operations that could not be performed in the human mind, or by a general-purpose computer utilizing conventional computing techniques, in a useful or reasonable timeframe.

Turning now to FIG. 2, a block diagram of another system 200 that facilitates analysis-driven automated infrastructure upgrades for data center servers is illustrated. Repetitive description of like parts described above with regard to other implementations is omitted for brevity. System 200 includes a performance modeler 110 and an upgrade recommendation engine 120 that can operate as described above with respect to FIG. 1 to provide proactive, analysis-driven upgrade recommendations for a computing system 20. System 200 further includes a data collector 210 that can facilitate collection of time series data at the computing system 20. The time series data collected by the data collector 210 from the computing system 20 can include the benchmark data utilized by the performance modeler 110 as described above and/or any other suitable data relating to performance of the computing system 20.

In implementations, the data collector 210 can facilitate transferal of benchmark data and/or other data collected from the computing system 20 to the ML model 10. This can be a direct transfer, e.g., a transfer of data directly from the data collector 210 to the ML model 10, or alternatively the data collector 210 can provide collected data to the performance modeler 110, which in turn can transfer the data to the ML model 10. Additionally, the data collector 210 can, in some implementations, facilitate collection of relevant data locally at the computing system 20, e.g., via a script and/or other means, and then facilitate transfer of the locally collected data to the performance modeler 110 and/or ML model 10 subsequent to collection. Alternatively, data can be provided by the computing system 20 to the data collector 210 in real time, e.g., pursuant to a data collection agreement.

Data collected by the data collector 210 from the computing system 20 can include any data that can be used by the ML model 10 for predicting future performance metrics of the computing system 20. This can include configuration information associated with the computing system 20 (e.g., hardware components or devices installed at the computing system 20, configuration settings associated with those hardware components or devices, installed software applications and/or their settings, etc.), benchmarking data associated with workloads performed by the computing system 20, and/or other types of data. Benchmark data that can be collected by the data collector 210 can include, but are not necessarily limited to, central processing unit (CPU) load metrics, memory usage metrics, network metrics (e.g., network throughput, data loss rate, average or peak latency, etc.), storage usage metrics, graphics processing unit (GPU) and/or data processing unit (DPU) benchmarking data, and/or other types of data.

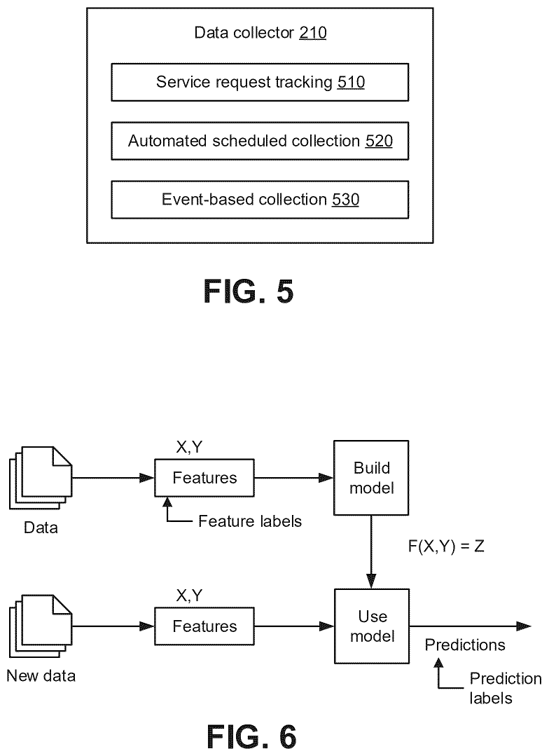

In implementations, data can be collected by the data collector 210 according to a schedule, in response to events, and/or in other circumstances. Criteria that can be used by the data collector 210 in determining when to collect data from the computing system 20 are described in further detail below with respect to FIG. 5.

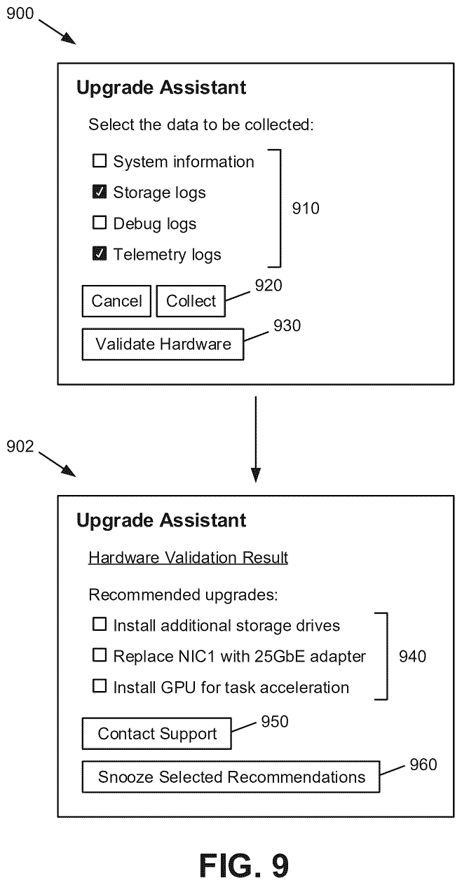

As further shown in FIG. 2, the upgrade recommendation engine 120 can provide system upgrade recommendations, and/or other information, back to the computing system 20. For example, the upgrade recommendation engine 120 can provide recommendations to a user of the computing system 20 via a graphical or text interface, an example of which will be described in further detail below with respect to FIG. 9. For instance, the upgrade recommendation engine 120 can provide recommendation data over a network or other communication link between the upgrade recommendation engine 120 and the computing system 20, e.g., to facilitate display of the recommendation data at the computing system 20. In other implementations, the upgrade recommendation engine 120 can be configured to perform upgrade related actions for the computing system 20 automatically, e.g., by changing basic input/output system (BIOS) settings or other configuration properties of the computing system 20, ordering new hardware components or devices, etc.

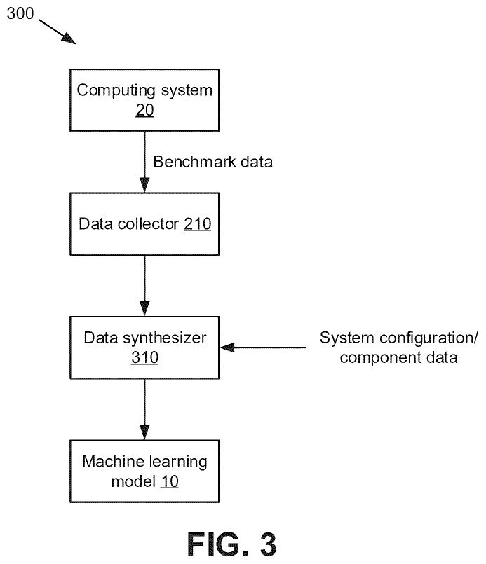

Referring next to FIG. 3, a block diagram of still another system 300 that facilitates analysis-driven automated infrastructure upgrades for data center servers is illustrated. Repetitive description of like parts described above with regard to other implementations is omitted for brevity. System 300 as shown in FIG. 3 includes a data synthesizer 310 that can facilitate providing time series data, e.g., benchmark data as collected from a computing system 20 by a data collector 210 as described above with respect to FIG. 2, to an ML model 10. The ML model 10, in turn, can predict future performance metrics of the computing system 20 in response to determining that the time series data has been successfully provided to the ML model 10 by the data synthesizer 310.

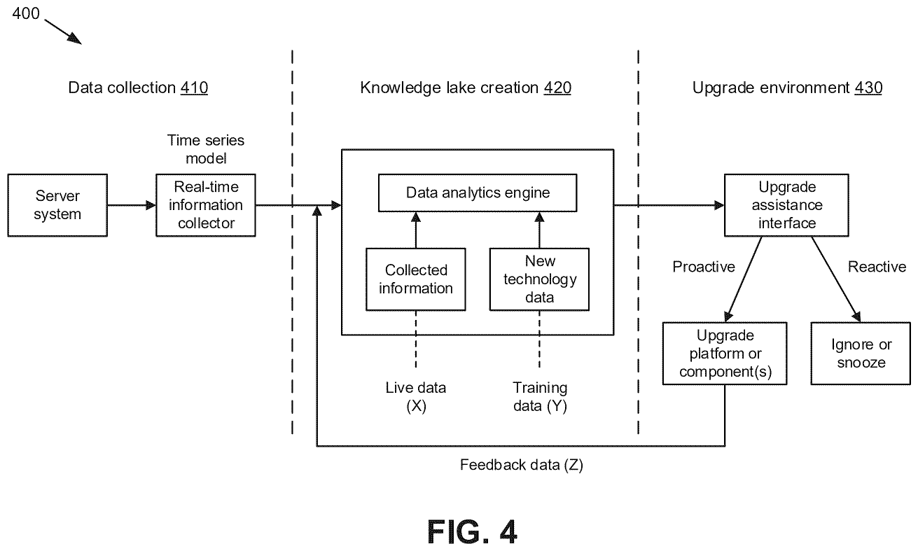

As further shown in FIG. 3, the data synthesizer 310 can additionally provide other data to the ML model 10, such as system configuration data relating to available hardware components for the computing system 20, configuration information for those components, candidate system configurations constructed from one or more of the hardware components, etc. For instance, as will be described in further detail below with respect to FIG. 4 and FIG. 6, the data synthesizer 310 can facilitate providing training data to the ML model 10 based on historical benchmark data and associated system configuration data, as well as live data corresponding to the measured performance of a given computing system 20.

Turning now to FIG. 4, a diagram depicting an example three-phase framework 400 that can be utilized to facilitate analysis-driven automated infrastructure upgrades for data center servers is provided. As shown by the framework 400, the performance of a server system can be analyzed, based on which an administrator or other user or entity associated with the server system can be presented with information regarding new enhancements available and/or if upgrades are recommended for the server system and/or component(s) of the system at a given point in time. As shown in FIG. 4, the framework includes three phases: a data collection phase 410 in which data is collected using a time series model, a knowledge lake creation phase 420, and an upgrade environment phase 430 in which recommendations are presented and/or automated actions are taken. Each of the phases 410, 420, 430 shown in FIG. 4 will now be described in further detail, beginning with the data collection phase 410.

In the data collection phase 410, benchmark data and/or other suitable data can be collected from the server system (e.g., by a data collector 210, as described above with respect to FIGS. 2-3) and absorbed into a real-time information collector using a time series model. In an implementation, the time series model can be an autoregressive integrated moving average (ARIMA) model, which can be used to forecast server performance parameters such as throughput, bandwidth, processing speed, and/or other metrics, by analyzing the collected data. In an implementation, collection of data on the server system can be performed via the operating system of the server system, e.g., via one or more operating system functions. Alternatively, applications, scripts, and/or other software components running on the operating system of the server system could also be used. As will be described in further detail below, data collected from the server system can later be channeled into an analytics engine for predictive analysis.

In implementations, the ARIMA model can be used to monitor the server data periodically and/or in response to events or other triggering criteria. Various techniques that can be utilized by the data collector 210 for collecting relevant data during the data collection phase 410 is shown by FIG. 5. As FIG. 5 illustrates, the data collector 210 can utilize a service request tracking procedure 510 to collect data associated with service requests made regarding a server system or other computing system (e.g., a computing system 20 as described above), such as requests to upgrade a component of the system and/or troubleshoot a failure of the system and/or one or more of its components.

As further shown in FIG. 5, the data collector 210 can collected data according to an automated scheduled collection procedure 520, e.g., in which the data collector 210 retrieves data associated with a server system or other computing system at regular intervals (e.g., 2 minutes, 15 minutes, 1 hour, 24 hours, etc.). Also or alternatively, the data collector 210 can perform an event-based collection procedure 530, in which performance data associated with a given computing system is collected in response to a triggering event, e.g., a server or component failure, a monitored load level of a component of the system reaching a threshold amount, etc. Other techniques for collecting data could also be used by the data collector 210.

Returning to FIG. 4, information collected from the server system during the data collection phase 410, and/or other data associated with the time series model, can be passed to a data analytics engine (DAE) as an input parameter for live data. The output of the data collection phase 410 can result in collecting data from the server system, which can include system information, and saving that data for future analysis. In implementations, both live data and historical data can be collected during the data collection phase 410 and stored in the same and/or different data stores. By way of example, live and/or forecasted data collected from a server as shown in FIG. 4 can be stored locally on the server, while system information and/or historical data logs can be saved at a centralized location, e.g., another server or computing device on which the DAE is trained, for accurate analysis. In general, however, both live and historical logs can be collected, e.g., to identify differences in events such as critical system events, informational events, or warnings.

Turning now to the knowledge lake creation phase 420 shown in FIG. 4, a knowledge lake (data lake), and/or other suitable data structures, can be created with a set of input parameters including live data (denoted as X in the drawings) and training data (denoted as Y in the drawings) to aid in decision making. The live data shown in FIG. 4 can include data local to the server system, which can use an ARIMA model or other time series model as described above to get real-time statistics for respective components of the server system.

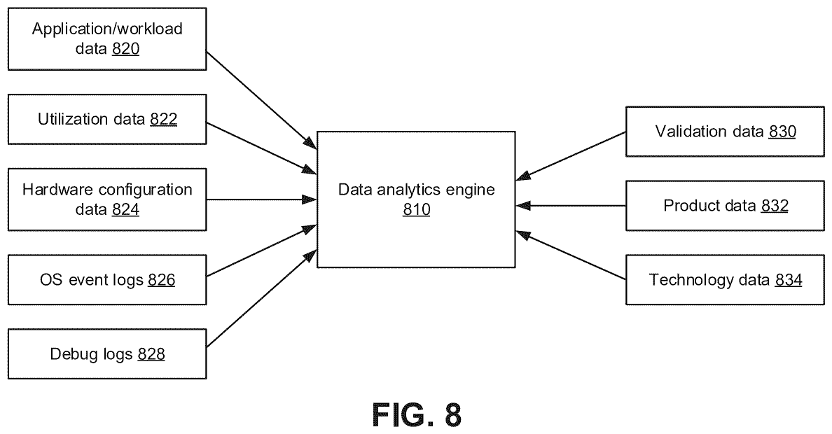

The training data shown in FIG. 4 can include historical data, system and/or technology data, and/or other data that can be used for training the DAE. As described above, the training data can, in some implementations, be stored at a centralized location at which the DAE is trained, which may be the same location, or a different location, as the location of the server system. The training data can facilitate a continuous pattern learning process at the DAE, which can continue to update each period whenever new information is received. An example pattern learning process that can be used in this manner is described in further detail below with respect to FIG. 8.

The DAE shown in FIG. 4 is a machine learning (ML) intelligence engine, which can use one or more algorithms to categorize the usage of hardware and/or workloads running at the server system. The DAE can intelligently decide and suggest corrective actions based on real-time data, e.g., as received dynamically via the data collection phase 410. In implementations, the DAE can use natural language processing (NLP) techniques and ML combinations with log picture analysis to aid in categorizing data quickly.

In the event that hardware mismatches are detected, the DAE can propose hardware upgrades and/or replacement with comprehensive insights, detailed justifications, and/or root cause explanations to enhance the ability of a user to build the correct infrastructure for their individual needs. These suggestions are described in further detail below with reference to the upgrade environment phase 430. In general, the output of the knowledge lake creation phase 420 can be a progressive learning model that can continuously monitor the server system and provide alerts if recommended upgrades to the server system are identified.

As described above, the DAE can work with two distinct datasets: live data (X), which is specific to a given server system, and training data (Y), which is used to train the model. These datasets serve as input variables to one or more ML algorithms utilized by the DAE for its analysis. In an implementation, the ML employed by the DAE can be trained with the primary purpose of making predictions regarding the suitability of complex data center workloads in relation to existing hardware infrastructure.

An overall process that can be used by the DAE for building and using an ML model is shown in FIG. 6. As shown by FIG. 6, the model can initially be built using a dataset that is divided into test data (X) and training data (Y). More particularly, the training data can be used to build the model, while the test data can be used to assess the quality of the model. The test data can be live data local to a given server system, e.g., in a test environment, that can use an ARIMA time series model and services that are used to obtain real-time statistics for each component of the server, e.g., as described above with reference to the data collection phase 410. The training data, which can include centralized historical data and/or other data, can facilitate a continuous pattern learning process, which can update over respective timer intervals whenever new system requirements and/or use cases are identified.

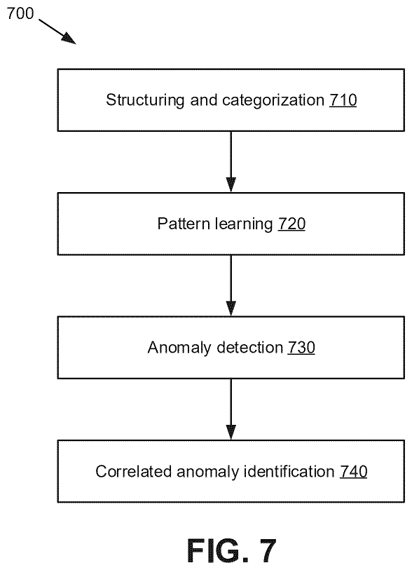

An example of a pattern learning process 700 that can be performed by the DAE is shown by FIG. 7. The pattern learning process 700 begins with a structuring and categorization phase 710, in which unsupervised ML automatically structures and categorizes log events. Next, during a pattern learning phase 720, the ML model learns patterns associated with each type of log event. During an anomaly detection phase 730, each new incoming event can be scored based on how anomalous it is, e.g., based on the similarity between each incoming event and other events known by the system. Finally, during a correlated anomaly identification phase 740, the ML model can look for correlated clusters of anomalies across logs.

Returning now to FIG. 6, an ML model as built as described above can be provided new data, e.g., live server benchmark data (X) or other performance/configuration data associated with live computing environments, new training data (Y) corresponding to new available hardware components and/or configurations, etc., to perform further operations. By way of example, live data from a given server environment can be processed by the ML model to predict a future loading level of components of that server environment for predicted future workflows. These predicted performance metrics can then be compared to predicted performance metrics for other components or configurations, e.g., components or configurations provided as training data to the model, to determine appropriate upgrade recommendations.

Turning now back to FIG. 4, a knowledge lake produced by the knowledge lake creation phase 420 can be based on multiple models managed by the DAE, such as a training model that is continually trained on new hardware components and updates as those components and/or updates are released, as well as a live (or test) model that runs on a local server environment and uses data collected locally at the server environment to generate recommendations. As the training model is continually trained, the live model at the server environment can be updated periodically to reflect this new training. Accordingly, training of a recommendation model can be performed at a central location with computing resources that are more suitable for ML model training, while predictions and recommendations made pursuant to that model can be offloaded to a local computing site, which need not have the resources for training the model.

FIG. 8 illustrates examples of information that can be processed by a DAE 810, e.g., in the knowledge lake creation phase 420 shown by FIG. 4. The left hand side of FIG. 8 represents live data types that can be utilized by the DAE 810, including application and/or workload data 820 relating to applications or workloads performed by a given system, utilization (benchmark) data 822 relating to resource usage metrics (e.g., CPU utilization, memory usage, storage availability, etc.) associated with performing applications and/or workloads at the system, hardware configuration data 824 relating to hardware components installed at the system and/or their configuration settings, operating system (OS) event logs 826 and/or debug logs 828 that provide information relating to tasks performed by the system and/or errors encountered in the performance of those tasks, and/or other suitable data. The right hand side of FIG. 8 represents training data types that can be fed to the DAE 810, validation data 830 and/or other data, product data 832 relating to new available features and/or technologies, which in some cases can include marketing materials, and technology data 834, which can include information pertaining to new hardware components and/or configurations, e.g., that enables simulation of those components and/or configurations by the DAE 810. Other types of information could also be provided to the DAE 810 for input.

Moving now to the upgrade environment phase 430 of FIG. 4, recommendations generated by the DAE during the knowledge lake creation phase 420 can be provided to an upgrade assistance interface, e.g., which can be rendered on a display screen associated with the server system and/or other suitable output devices. An example user interface (UI) that can be used for this purpose is shown in FIG. 9. Diagram 900 in FIG. 9 illustrates an initial state of an upgrade assistant interface. In this initial state, the interface can include a menu 910 of data sources from which data for upgrade recommendations can be collected. In the example shown in FIG. 9, these data sources are listed as individual items which can be manually enabled or disabled, e.g., by an administrator or other user. In other implementations, some or all data collection could be done automatically, e.g., pursuant to a data collection agreement between a system administrator and a provider of the upgrade assistant service. Collection on some or all of the data sources listed in the menu 910 can be performed manually, e.g., by the use of a collect button 920, or alternatively data can be collected on a regular schedule. In implementations, scheduled data collection could be configured by an administrator or other user via other portions of the UI not shown in FIG. 9.

As further shown in diagram 900, an additional UI element, here a validate hardware button 930, can be provided. In implementations, operation of the DAE and upgrade recommendation engine can be triggered via activation of the validate hardware button 930. For instance, in response to a user pressing the validate hardware button 930, hardware checks can be performed on the local system, and a report can be generated with results of those checks, an example of which is shown by diagram 902.

As shown in diagram 902, if the report identifies recommended upgrades to the local system, those recommendations can be provided in a list 940 and/or other suitable display format. The UI can additionally provide a button 950 or other control element that can connect to support, marketing, and/or sales teams for further action on the recommended upgrades. As further shown, a second button 960 can also be provided to enable an administrator to snooze or ignore respective recommendations, cither temporarily (e.g., for a configurable time period) or permanently. In the event that a recommendation is snoozed or ignored, this can be provided back to the DAE as feedback data (Z) as further shown by FIG. 4.

If an upgrade or a change shown in the list 940 is selected, system parameters associated with those selections can be monitored with respect to newly added hardware (e.g., resulting from the recommendation) and overall system performance resulting from the change. This data can then be fed as a feedback loop to the DAE, which can utilize the data to strengthen its central model.

In an implementation, the upgrade assistant interface shown in FIG. 9 can be implemented as part of a technical support system for a given computing environment, and can facilitate collection of data either locally or to a shared network location. In addition to providing a UI as shown in FIG. 9, this technical support system can also evaluate the health of servers, storage, and networking devices, and/or other devices, to perform proactive maintenance to prevent or mitigate system downtime. This technical support system can also collect debug information, telemetry logs, and/or other information used by the DAE for recommendations. In some implementations, recommendations provided by this system can be displayed to a system administrator in the form of pop-ups or alerts in addition to, or in place of, the interface shown in FIG. 9.

Discussion now turns to example operations that can be performed by system 200 as shown in FIG. 2 in order to provide further context for the implementations described herein. In general, the performance modeler 110 can obtain data associated with a computing system 20 as collected by the data collector 210, such as configuration data and performance data, and predict future performance metrics for the computing system 20 based on the information provided. The upgrade recommendation engine 120 can then provide recommendations for upgrades to the computing system 20 based on the output of the performance modeler 110.

In some implementations, a recommendation given by the upgrade recommendation engine 120 can be associated with one or more specific hardware devices of the computing system 20. For example, the upgrade recommendation engine 120 could, based on the output of the performance modeler 110, recommend an action such as replacing a hardware device of the computing system 20 with a different hardware device and/or adding an additional hardware device to the computing system 20. In other implementations, the upgrade recommendation engine 120 can also recommend changes to configuration properties of a given hardware device, e.g., BIOS settings or the like, to optimize performance of existing hardware. The upgrade recommendation engine 120, in some implementations, can also supplement a recommendation with an explanation of reasons for the recommendation, e.g., by providing a statement in a UI such as that shown in FIG. 9 along with provided recommendations.

Specific, non-limiting examples of recommendations that can be provided by the upgrade recommendation engine 120 for an example computing system 20 are now provided below. In the example provided below, the computing system 20 can run a storage cluster, e.g., a virtualized storage area networking (V-SAN) cluster, on respective server nodes, each of which runs a group of virtual machines. Table 1 as shown below provides example configuration data for one of the server nodes of the computing system 20, along with average resource usage levels measured by the data collector 210 over a defined period of time (e.g., the past six months). It is noted that the example given by Table 1 is merely for purposes of illustration and is not intended to be an exhaustive listing of components or metrics that can be processed by system 200. It is additionally noted that details regarding manufacturers, model numbers, and/or other product-specific details are omitted from Table 1 to further generalize this description.

TABLE 1
Example server hardware components and
corresponding resource usage metrics.

| | Average resource |
|---|---|
| Server component | usage in production |
| CPU - Model A1, 2.80 GHz, 16 core | High: 90-95%, peaks |
| processors | to ~98% |
| Memory - 32 GB DDR4-2666 | Moderately high: 70-80% |
| Caching tier - NVMe model B1 SSD, 375 GB | High: 95% |
| Capacity tier - NVMe model C1 SSD, 1 TB | High: 90-97% |
| Boot device - RAID controller card with | Average: 20-40% |
| M.2 sticks (120 GB, RAID 1) | |
| NIC 1 - NIC model D1 for 10 Gb Ethernet | High: 90% |
| NIC 2 - NIC model E1 for 25 Gb Ethernet | Moderately high: 75% |
| Capacity tier - NVMe model C1 SSD, 2 TB | High: 90-97% |

In the above example, the performance modeler 110 can analyze data collected by the data collector 210 from the computing system 20 over a period of time, based on which the upgrade recommendation engine 120 can suggest respective upgrade options after comparing the collected data with real-time data from the knowledge lake described above.

By way of example, the performance modeler 110 can infer from the data provided in Table 1 that, because a V-SAN solution is a storage, compute, and network-intensive workload solution and the capacity and cache tier data stores are already exhausted, any further increase on the workload would adversely impact storage input/output performance, thereby creating a bottleneck on the storage tier. For this reason, the upgrade recommendation engine 120 could issue a recommendation as shown in Table 2 below:

TABLE 2
Example storage upgrade recommendation.

Increase capacity and cache tier by replacing existing drives with larger
and faster drives.
Existing: Capacity tier - NVMe model C1 SSD, 1 TB
Replace with: NVMe model C2 SSD, 1.6 TB

Similarly, the performance modeler 110 could infer from the data provided in Table 1 that because the first network interface controller (NIC) is under heavy average load, further increases in average network traffic could create a similar bottleneck. Accordingly, the upgrade recommendation engine 120 could issue a recommendation as shown in Table 3 below:

TABLE 3
Example networking upgrade recommendation.

Replace NIC 1 with new adapters for better networking performance.
Existing: NIC model D1 for 10 Gb Ethernet
Replace with: NIC model D2 for 25 Gb Ethernet

As a further example, the performance modeler 110 could compare performance data associated with the computing system 20 as collected by the data collector 210 to training data associated with other similarly configured systems to recommend optimizations. For instance, the performance modeler 110 could determine that some of the CPU usage shown in Table 1 could be reduced by offloading infrastructure tasks to a GPU, e.g., based on training data associated with the ML model 10 collected from systems that perform such offloading. To this end, the upgrade recommendation engine 120 could issue a recommendation as shown in Table 4 below:

TABLE 4
Example hardware addition recommendation.

To increase application response time, offload infrastructure tasks to an
accelerator. An accelerator like a GPU can work on specific applications
and accelerate their performance by freeing up CPU/memory resources
for other applications and/or infrastructure services. Installing model F1
GPUs would help to accelerate these workloads.

While the above examples each relate to hardware upgrades, the upgrade recommendation engine 120 can also propose software upgrades for improved performance. For instance, the BIOS of the computing system 20 can provide performance tuning options through mechanisms such as workload profiles, performance profiles, etc., and the upgrade recommendation engine 120 can suggest changes to these profiles as appropriate.

As an example of the above, data from a system reflected in the training data of the ML model 10 can show that the system is running a high performance computing (HPC) workload with acceptable CPU performance results. On the other hand, data from the computing system 20 as collected by the data collector 210 can show that the computing system 20, while using the same hardware components, has degraded CPU performance results. The performance modeler 110 can analyze the difference in performance results, along with the configurations of the respective systems, and determine that differences in the BIOS settings of the computing system 20 are likely the cause of the degradation. In response, the upgrade recommendation engine 120 can provide a suggestion as shown in Table 5 below:

TABLE 5
Example BIOS configuration recommendation.

Adjust BIOS settings as follows:
Existing:
Logical Processors: Enabled
Turbo Boost: Disabled
Memory Operating Mode: Disabled
Replace with:
Logical Processors and Virtualization Technology: Disabled
Turbo Boost: Enabled
Memory Operating Mode: Optimizer

By recommending these BIOS configuration changes, the upgrade recommendation engine 120 can aim to optimize the CPU and memory performance of the computing system 20, ensuring that the system achieves improved results, particularly when running HPC workloads. This approach can help address performance discrepancies observed between different systems, tailoring system settings to match workload requirements and expectations.

In some implementations, the upgrade recommendation engine 120 can be configured to automatically apply recommended changes in addition to, or in place of, providing recommendations. Thus, the upgrade recommendation engine 120 could, in some implementations, automatically perform one or more of the recommended changes provided in Table 5 in the above example.

In implementations, the performance modeler 110 and/or the upgrade recommendation engine 120 can check component versions against a database, which can be updated at regular intervals (e.g., every quarter, etc.). If the current hardware versions of a given system are less than, or otherwise not the same as, any entry in the database, the upgrade recommendation engine 120 can show an upgrade proposal and compare it with the typical workloads of the system.

In some cases, the upgrade recommendation engine 120 could also, based on output from the performance modeler 110, recommend complete replacement of a server, e.g., instead of upgrading individual components. For instance, in a use case such as cluster management with multiple workloads running, in the event that the performance modeler 110 determines that even if the cluster was running with the latest supported hardware it still would not perform well, the upgrade recommendation engine 120 could recommend full replacement of the cluster.

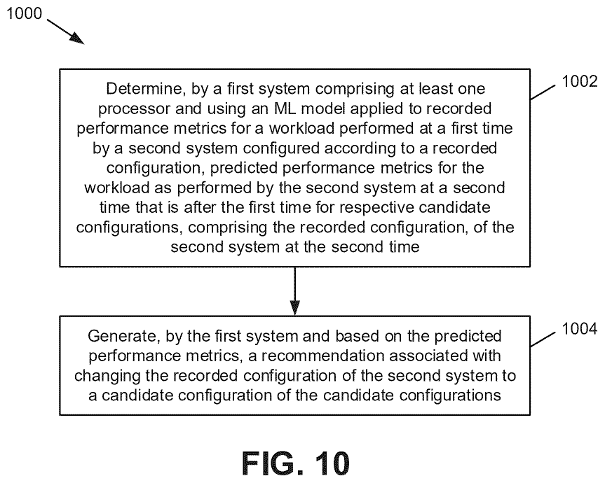

Turning to FIG. 10, a flow diagram of a method 1000 that facilitates analysis-driven automated infrastructure upgrades for data center servers is illustrated. At 1002, a first system comprising at least one processor can determine (e.g., by a performance modeler 110), using an ML model (e.g., an ML model 10) applied to recorded performance metrics for a workload performed at a first time by a second system (e.g., a computing system 20) configured according to a recorded configuration, predicted performance metrics for the workload as performed by the second system at a second time that is after the first time for respective candidate configurations, comprising the recorded configuration, of the second system at the second time.

At 1004, the first system can generate (e.g., by an upgrade recommendation engine 120), based on the predicted performance metrics determined at 1002, a recommendation associated with changing the recorded configuration of the second system to a candidate configuration of the candidate configurations.

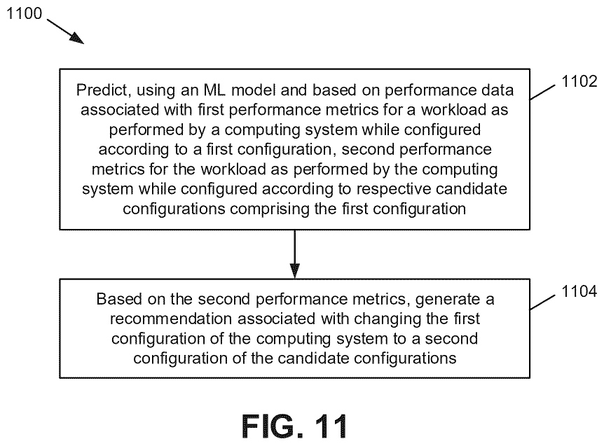

Referring next to FIG. 11, a flow diagram of a method 1100 that can be performed by at least one processor, e.g., based on machine-executable instructions stored on a non-transitory machine-readable medium, is illustrated. Example of computer architectures, including a processor and non-transitory media, that can be utilized to implement method 1000 are described below with respect to FIGS. 12-13.

Method 1100 can begin at 1102, in which the at least one processor can predict, using an ML model and based on performance data associated with first performance metrics for a workload as performed by a computing system while configured according to a first configuration, second performance metrics for the workload as performed by the computing system while configured according to respective candidate configurations comprising the first configuration.

At 1104, based on the second performance metrics, the at least one processor can generate a recommendation associated with changing the first configuration of the computing system to a second configuration of the candidate configurations.

FIGS. 10-11 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIGS. 12-13 and the following discussion are intended to provide a brief, general description of suitable computing environments 1200, 1300 in which the various embodiments of the embodiment described herein can be implemented. More particularly, FIG. 12 illustrates a general-purpose computing environment 1200 that can be utilized to implement some of the computer-executable components described above, while FIG. 13 illustrates a server computing environment 1300 on which deep learning models and/or other ML models as described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 12, an example general-purpose environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD), a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Turning next to FIG. 13, an example server architecture 1300 that can be utilized in connection with one or more implementations described above is illustrated. The server architecture 1300 shown in FIG. 13 can be associated with a server device, such as a rackmount server, a blade server, or the like, which can be physically and/or communicatively coupled to a chassis (not shown in FIG. 13) and/or other physical devices for use in a computing environment such as a computing cloud, a data center, etc.

The server architecture 1300 shown in FIG. 13, referred to below as simply a server for brevity, can include one or more central processing units (CPUs), here two CPUs 1310, 1312. In a typical implementation of the server 1300, the CPUs 1310, 1312 are high-performance server processors that provide scalability and a high number of processing cores per CPU, e.g., up to 56 cores per processor for current implementations. The CPUs 1310, 1312 of the server 1300 are communicatively coupled to each other by, e.g., processor interconnect links, such as QuickPath Interconnect (QPI) or Ultra Path Interconnect (UPI) links developed by the Intel® Corporation. Alternatively, other means for coupling the CPUs 1310, 1312, such as a front side bus (FSB) or the like, could also be used. While two interconnect links are shown in FIG. 13 coupling CPUs 1310 and 1312, it is noted that more, or fewer, links could also be used.

The CPUs 1310, 1312 shown in FIG. 13 are additionally coupled to a system memory 1320, which can include one or more Dual In-line Memory Modules (DIMMs) and/or other devices. While the system memory 1320 is illustrated as a single block in FIG. 13 for simplicity, it is noted that the system memory 1320 is typically implemented via a group of memory modules. For example, the CPUs 1310, 1312 can collectively be associated with a number of DIMM slots (e.g., 16 slots, 32 slots, etc.), and DIMMs making up the system memory 1320 can be placed into these slots to facilitate connection to the CPUs 1310, 1312. Depending on implementation, the memory modules making up the system memory 1320 can be communicatively coupled to one, or more, of the CPUs 1310, 1312.

As further shown in FIG. 13, Peripheral Component Interconnect Express (PCIe) switches 1330, 1332 can connect the CPUs 1310, 1312 to respective other components of the server 1300, such as network interfaces 1340, 1342, storage controllers 1350, 1352, or the like. The network interfaces 1340, 1342 can include network interface cards (NICs) and/or other suitable components to facilitate connecting the server 1300 to other servers or suitable computing devices, e.g., in a clustered computing environment. The storage controllers 1350, 1352 can include nonvolatile memory express (NVMe) controllers and/or other interface devices that facilitate the coupling of storage devices, such as non-volatile RAM (NVRAM) devices, SSDs, or the like, to the server 1300.

While FIG. 13 shows a configuration in which each CPU 1310, 1312 is connected to one PCIe switch 1330, 1332, other configurations could be used. For instance, a one-to-many or many-to-one connection scheme could be used between the CPUs 1310, 1312 and the PCIe switches 1330, 1332. Similarly, the network interfaces 1340, 1342 and storage controllers 1350, 1352 could be connected to the PCIe switches 1330, 1332 in a one-to-many or many-to-one configuration in addition to, or in place of, the one-to-one connection scheme shown in FIG. 13.

The server 1300 shown in FIG. 13 further includes a group of co-processors, such as graphics processing units (GPUs), intelligence processing units (IPUs) for artificial intelligence workloads or the like. In FIG. 13, there are eight GPUs 1360-1367, which provide further processing capability to server 1300. While eight GPUs 1360-1367 are shown in FIG. 13, more, or fewer, GPUs could also be used. The GPUs 1360-1367 of server 1300 are preferably specialized GPUs that are designed for high-performance computing applications, such as H100 and/or A100 GPUs developed by the NVIDIA® Corporation, although other GPUs, IPUs, etc., could also be used. Each of the GPUs 1360-1367 of the server are communicatively coupled to each other via suitable communications links, such as NVLink® interconnects developed by the NVIDIA® Corporation and/or other suitable connections. In the example shown by FIG. 13, a GPU 1370 facilitates full interconnection between the GPUs 1360-1367. In other implementations, the GPUs 1360-1367 could instead be interconnected directly without the use of a switch or other means.

As additionally shown by FIG. 13, the GPU 1370 is communicatively coupled to the PCIe switches 1330, 1332 to enable communication between the GPUs 1360-1367 and other components of the server 1300. Other connection schemes could also be used. For instance, one or more of the GPUs 1360-1367 could connect to the PCIe switches 1330, 1332 and/or the CPUs 1310, 1312 directly, e.g., in an implementation in which a GPU 1370 is not present. In this architecture, deep learning models would be executed in the GPUs 1360-1367 rather than the CPUs 1310, 1312.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one memory that stores executable components; and
at least one processor that executes the executable components stored in the at least one memory, wherein the executable components comprise:
a performance modeler that predicts, using a machine learning model and based on benchmark data associated with past performance metrics for a workload as performed by a computing system configured according to a first configuration, future performance metrics for the workload for respective candidate configurations, comprising the first configuration, of the computing system; and
an upgrade recommendation engine that, based on the future performance metrics predicted by the performance modeler, generates a recommendation associated with changing the first configuration of the computing system to a second configuration of the candidate configurations.

2. The system of claim 1, wherein the executable components further comprise:
a data collector that facilitates collection of time series data at the computing system, the time series data relating to performance of the computing system and comprising the benchmark data.

3. The system of claim 2, wherein the executable components further comprise:
a data synthesizer that facilitates providing the time series data to the machine learning model, and
wherein the performance modeler predicts the future performance metrics in response to the time series data being determined to have been successfully provided to the machine learning model.

4. The system of claim 3, wherein the data synthesizer further provides, to the machine learning model, system configuration data relating to the candidate configurations of the computing system.

5. The system of claim 1, wherein the benchmark data is associated with a hardware device of the computing system.

6. The system of claim 5, wherein the hardware device is a first hardware device, and wherein the recommendation generated by the upgrade recommendation engine relates to an action selected from a group of actions comprising (1) replacing the first hardware device with a second hardware device that is not the first hardware device and (2) adding a third hardware device to the computing system that is not the first hardware device or the second hardware device.

7. The system of claim 5, wherein the benchmark data relates to performance of the hardware device while configured according to a first configuration property, and wherein the recommendation generated by the upgrade recommendation engine relates to changing the first configuration property of the hardware device to a second configuration property that is not the first configuration property.

8. The system of claim 1, wherein the machine learning model is trained using first data associated with first hardware of the computing system and second data associated with second hardware, comprising the first hardware and at least one other hardware other than the first hardware.

9. The system of claim 8, wherein the performance modeler constructs respective ones of the candidate configurations using respective groups of the second hardware.

10. The system of claim 1, wherein the recommendation generated by the upgrade recommendation engine comprises an explanation of a reason for the recommendation.

11. A method, comprising:
determining, by a first system comprising at least one processor and using a machine learning model applied to recorded performance metrics for a workload performed at a first time by a second system configured according to a recorded configuration, predicted performance metrics for the workload as performed by the second system at a second time that is after the first time for respective candidate configurations, comprising the recorded configuration, of the second system at the second time; and
generating, by the first system and based on the predicted performance metrics, a recommendation associated with changing the recorded configuration of the second system to a candidate configuration of the candidate configurations.

12. The method of claim 11, further comprising:
facilitating, by the first system, collection of time series data at the second system, the time series data comprising the recorded performance metrics for the workload.

13. The method of claim 12, further comprising:
facilitating, by the first system, a transfer of the time series data from the second system to the machine learning model, wherein the determining of the predicted performance metrics is in response to the time series data being determined to have been successfully transferred to the machine learning model.

14. The method of claim 11, wherein the recorded performance metrics relate to a hardware component of the second system.

15. The method of claim 14, wherein the hardware component is a first hardware component, and wherein the recommendation relates to an action selected from a group of actions comprising:
replacing the first hardware component with a second hardware component that is not the first hardware component and
adding a third hardware component to the second system.

16. The method of claim 14, wherein the recorded performance metrics further relate to a first configuration property of the hardware component, and wherein the recommendation relates to changing the first configuration property of the hardware component to a second configuration property that is not the first configuration property.

17. A non-transitory machine-readable medium comprising computer executable instructions that, when executed by at least one processor, facilitate performance of operations, the operations comprising:
predicting, using a machine learning model and based on performance data associated with first performance metrics for a workload as performed by a computing system while configured according to a first configuration, second performance metrics for the workload as performed by the computing system while configured according to respective candidate configurations comprising the first configuration; and
based on the second performance metrics, generating a recommendation associated with changing the first configuration of the computing system to a second configuration of the candidate configurations.

18. The non-transitory machine-readable medium of claim 17, wherein the operations further comprise:
collecting the performance data from the computing system as time series data; and
transferring the time series data to the machine learning model, wherein the predicting of the second performance metrics is in response to the time series data being determined to have been successfully transferred to the machine learning model.

19. The non-transitory machine-readable medium of claim 17, wherein the performance data is associated with a hardware device of the computing system.

20. The non-transitory machine-readable medium of claim 19, wherein the hardware device is a first hardware device, and wherein the recommendation relates to an action selected from a group of actions comprising:
replacing the first hardware device with a second hardware device that is not the first hardware device,
adding a third hardware device to the computing system, and
changing a configuration property of the first hardware device.
